(19) United States
(12) Patent Application Publication
(10) Pub. No.: US 2006/0049549 A1
(43) Pub. Date: Mar. 9, 2006

(54) METHOD FOR IMPROVING FORMATION AND PROPERTIES OF SPUNBOND FABRIC

(76) Inventors: Anders Moller, Pompano Beach, FL (US); Fumin Lu, Tamarac, FL (US)

Correspondence Address: MALIN HALEY AND DIMAGGIO, PA, 1936 S ANDREWS AVENUE, FORT LAUDERDALE, FL, 33316, US

(21) Appl. No.: 11/161,663

(22) Filed: Aug. 11, 2005

Related U.S. Application Data
(60) Provisional application No. 60/522,087, filed on Aug. 12, 2004.

(51) Int. Cl. B29C 47/00; H05B 7/00

(52) U.S. Cl. 264/466

(57) ABSTRACT

Method and apparatus to reduce or eliminate undesirable filament bundles in a spunbond generating process that includes providing a spin beam that has a source of polymer melt, a spinneret for forming individual filaments of said polymer melt and a drawing unit that draws the filaments from the spinneret for depositing on a web forming means below the drawing unit. The spin beam includes one or more embedded electrodes that charge electrostatically the polymer melt that is used to form the filaments in the spinneret with like charges. By having filaments of a similar electrostatic charge (which is a repelling force), bundling is eliminated. The apparatus and method may also include providing an additional electrostatic charge at the entrance of the drawing unit for further electrostatically charging the filaments.

### FIELD OF THE INVENTION

This invention relates generally to a method for creating spunbond fabric that includes the use of a spinneret and drawing unit and, specifically, to a method for generating spunbond fabrics that can be used to reduce the formation of filament bundles on a fabric therefore improving its appearance and tensile properties. The method further can be used in a spunbond process to substantially alter the laid down uniformity of filaments resulting in a lowered ratio of tenacity of machine direction versus cross machine direction (MD/CD).

### DESCRIPTION OF RELATED ART

In a spunbond process, filament curtains that emanate from the spinneret consist of tens of thousands of filaments spun from the spinneret and drawn down by means of aspirators or guns using pressurized air or low pressure vacuum. The curtain of filaments is eventually laid down on a wire conveyor belt to form a fabric through a bonding process that could be from calendaring, needle punching or hydro-entangling, depending upon the requirements of the product being produced. The fabrics that are produced from the spunbond process have characteristics and properties such as strength ratio of the machine direction versus the cross machine direction. The machine direction strength ratio is affected by the degree of filament separation from each other and the randomness of the filaments that are laid down on the wire conveyor belt. The closeness or separation of the filaments is materially affected by bunching or bundling where the filaments actually contact each other and are not separated properly. It has long been a problem in spunbond manufacturing to maintain filament separation throughout the entire process. If the tiny filaments stick together, they form undesirable bundles that affect the final fabric.

U.S. Pat. No. 5,397,413 issued to Trimble, et al. on Mar. 14, 1995 describes an apparatus and method for producing a web of thermoplastic filaments that creates an electrostatic corona discharge at the base of the drawing unit in order to induce electrostatic charges on the filaments before they are deposited upon a forming belt.

U.S. Pat. No. 5,296,172 issued to Davis, et al. on Mar. 22, 1994 shows an electrostatic field enhancing process and apparatus for improved web spinning that provides and imposes an auxiliary electrostatic field above the fibrous web and is pinned along a moving collection surface.

U.S. Pat. No. 5,762,857 issued to Weng, et al. on Jun. 9, 1998 shows a method for producing non-woven web using pulsed electrostatic charge in which the electrode is positioned below the base of the drawing unit to induce electrostatic charge on the filaments.

U.S. Pat. No. 6,709,623 issued to Haynes, et al. on Mar. 23, 2004 shows a process of an apparatus for making a non-woven web that applies an electrostatic charge at the base of the drawing unit.

### SUMMARY OF THE INVENTION

The present invention overcomes the problems of the prior art by providing a method and apparatus that is embedded in the spin beam and that electrically charges the polymer melt that is used to form the filaments in the spinneret. The filaments are formed leaving the spinneret holes. Using the present invention, the polymer melt material is electrically inductively charged through one or more electrodes embedded in the spin beam. Being of the same electrical charge, the melt and resulting filaments are therefore continuously separated from each other by the electrostatic force of like charges repelling. The apparatus may further include additional electrostatic charging at the entrance to the drawing unit which is used to draw down the filaments from the spinneret. This will further enhance the charging on the filaments causing them to remain separated by electrostatic force or induction.

The effect of filaments being charged and repelling each other improves the web laid down process with more randomized filament laid down because of increased filament separation. Thus, the fabrics produced by this spunbond process have a better appearance and higher tenacity and a lower machine direction/cross machine direction ratio.

It is an object of this invention to provide a spunbond process and apparatus to reduce filament bundling by inducement of electrical charges into the polymer melt embedded in the spin beam such that as the resulting filaments emanate from the spinneret, the individual filaments each have the same polarity of electrical charges (negative or positive) to repel each other for filament separation purposes throughout the fabric forming process.

It is another object of this invention is to provide a spunbond process and apparatus that will be used to laid down filaments that result in better tenacity and machine direction versus cross machine direction ratios for a more uniform fabric of a high tenacity by reducing filament bundling.

### DETAILED DESCRIPTION

A method and apparatus for making spunbond fabric and generating spunbond filaments that form a fabric comprising a spinneret, an aspirator or drawing unit for drawing the filaments from the spinneret, and a laid down conveyor wire below the drawing unit for creating the fabric upon which the filaments are directed and drawn. A polymer material is placed and melted in the spin beam and the spinneret. The molten polymer is placed under high pressure, forcing the polymer melt through small holes in the spinneret. Inside the embedded chamber in the spin beam where the polymer is melted is one or more electrodes for generating an electric field, inductively charging the close-by polymer molecules with charges of the same polarity. The electrodes are connected to a D.C. voltage source and spaced so that a particular (positive or a negative) charge is induced in the molten polymer material. As the molten material is forced out of the spinneret holes under high pressure, the electrostatic charges of the same polarity (plus or minus) on the molten material will remain with the melt material that forms the filaments as filaments are created and drawn out of the spinneret. The charged filaments are drawn down into the drawing unit and during that process remain charged, thereby separating each other from adjacent filaments with repulsive electrical charges. Like charges (positive or negative) repel each other and therefore each of the filaments having the like charges repel each other, also maintaining filament separation. The drawing unit may also include one or more electrodes positioned along the top leading edge of the drawing unit where the filaments enter to create and additionally charge the filaments as the filaments pass through the drawing unit.

Using the present apparatus and method, filament bundling is greatly reduced or eliminated.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of preventing filament bundling in a spunbond filament generating process comprising the steps of:
a. providing a spin beam that includes an embedded source of polymer melt;
b. inducing an electrostatic field in said polymer melt source to induce like electrostatic charges on said polymer melt;
c. forcing said charged polymer melt into a spinneret to create a plurality of individually charged filaments of the same electrostatic charge;
d. drawing said charged filaments through a drawing unit from said spinneret; and
e. depositing said charged filaments on a web forming belt.

2. The method as in claim 1, including the step of:
f. charging the filaments entering the drawing unit with an additional electrostatic charge.

3. Apparatus for removing filament bundles from spunbond filaments comprising:
spin beam for providing an embedded source of polymer melt;
means for generating an electrostatic field in said spin beam to create like charges on said polymer melt;
spinneret in communication with said spin beam polymer melt for generating individual filaments from said like charged polymer melt;
drawing unit for drawing said charged filaments from said spinneret; and
web forming means below said drawing unit for forming a web of said charged filaments deposited on said web forming means.

4. Apparatus as in claim 3, including:
means for providing like electrostatic charges on said filaments as the filaments enter said drawing unit.
